(19) United States
(12) Patent Application Publication
(10) Pub. No.: US 2011/0019636 A1
(43) Pub. Date: Jan. 27, 2011

(54) WIRELESS COMMUNICATION BASE STATION DEVICE AND WIRELESS COMMUNICATION METHOD

(75) Inventors: Masaru Fukuoka, Ishikawa (JP); Akihiko Nishio, Kanagawa (JP); Daichi Imamura, Kanagawa (JP)

Correspondence Address: Dickinson Wright PLLC;James E. Ledbetter, Esq., International Square, 1875 Eye Street, N.W., Suite 1200, Washington, DC, 20006, US

(73) Assignee: PANASONIC CORPORATION, Osaka (JP)

(21) Appl. No.: 12/933,849

(22) PCT Filed: Mar. 24, 2009
(86) PCT No.: PCT/JP2009/001287

§ 371 Date: Sep. 21, 2010

(30) Foreign Application Priority Data
Mar. 25, 2008 (JP) 2008-079032

(51) Int. Cl. H04W 72/04

(52) U.S. Cl. 370/329

(57) ABSTRACT

Provided is a wireless communication base station device that can avert PHICH collisions between mobile stations when using a frequency hopping retransmission method in combination with a PHICH grouping method. A base station (100) is used in a wireless transmission system in which uplink data is allocated to multiple resource blocks, each M consecutive resource blocks form a block (M being an integer greater than 1), and each N consecutive resource blocks form a group (N being an integral multiple of M). A demultiplexer (115) follows a hopping pattern which changes the frequency for each block of multiple resource blocks, and extracts from the resource blocks uplink data for each of multiple mobile stations. Also, a mapping unit (103) maps PHICHs, to which response signals for uplink data for each mobile station are allocated, to downlink resources in accordance with associations between groups and PHICHs.

### TECHNICAL FIELD

The present invention relates to a radio communication base station apparatus and a radio communication method.

### BACKGROUND ART

In recent years, various information, for example, images and data in addition to speech, have been transmitted by radio communication, in particular, mobile communication. Increased demand for high-speed transmission is expected in the future. As a radio communication technology to allow a high transmission efficiency, studies of LTE (Long Term Evolution), a next generation mobile communication system, are underway by 3GPP (3rd Generation Partnership Project). SC-FDMA (Single-carrier FDMA) is being discussed as the uplink access method according in LTE.

With SC-FDMA, uplink data is allocated to system band RBs (resource blocks) for every radio communication mobile station apparatus (herein after “mobile station”), and uplink data is frequency-division-multiplexed between mobile stations. By this means, it is possible to communicate uplink data between mobile stations without collision.

In addition, with mobile communication, ARQ (Automatic Repeat reQuest) is applied to uplink data transmitted from each mobile station to a mobile communication base station apparatus (hereinafter “base station”) in the uplink, and a response signal indicating the error detection result of uplink data is fed back to each mobile station in the downlink. A base station performs CRC (cyclic redundancy check) detection on uplink data, and, when CRC=OK (there is no error), feeds an ACK (Acknowledgment) signal back to the mobile station as a response signal, and, when CRC=NG (there is an error), feeds a NACK (Negative Acknowledgment) signal back to the mobile station as a response signal.

Here, studies are underway to apply synchronous HARQ (synchronous Hybrid ARQ) to uplink data. With synchronous HARQ, after a certain period of time passes after a base station receives uplink data, the base station feeds a response signal back to each mobile station. Upon receiving a NACK signal from the base station as feedback, each mobile station retransmits uplink data using predetermined RBs after a certain period of time passes after receiving the NACK signal.

In addition, as the retransmission method in synchronous HARQ, there is an PH (frequency hopping) retransmission method for hopping the RBs to allocate uplink data, between the time of the first transmission and the time of retransmission. With the FH retransmission method, RBs to allocate uplink data are different between the time of the first transmission and the time of retransmission, so that it is possible to produce frequency diversity effect. Here, a preset FH pattern is shared between a base station and each mobile station, so that communication between them is performed by detecting frequency-hopped RBs to which uplink data at the time of retransmission is allocated.

As FH patterns used in the FH retransmission method, one FH pattern in which a plurality of RBs to allocate uplink data are blocked into a plurality of blocks every plurality of consecutive RBs and a plurality of RBs are hopped per block and another FH pattern in which RBs are mirrored, are under study (for example, see Non-Patent Document 1). With the FH pattern to hop RBs per block, for example, all uplink RBs are divided into two half-blocks and hopped per block. In this case, uplink data at the time of retransmission is allocated to RBs in the block different from the block constituting RBs to which the uplink data was allocated at the time of the first transmission. Meanwhile, in the FH pattern to mirror RBs, an RB of a smaller RB number is hopped to an RB of a larger RB number. That is, uplink data at the time of retransmission is allocated to RBs of RB numbers having the mirror image relationship with RB numbers of RBs to which uplink data was allocated at the time of the first transmission.

In addition, a base station uses PHICHs (Physical Hybrid-ARQ Indicator Channels) as control channels to feed, in the downlink, a response signal back to each mobile station having transmitted uplink data. PHICHs are multiplexed with other channels in the downlink in the base station and transmitted to each mobile station. In addition, PHICHs are control channels required per mobile station and need to be allocated for every mobile station.

Moreover, in order to efficiently use communication resources in the uplink using synchronous HARQ, studies are under way to associate uplink RBs to allocate uplink data with PHICHs for transmitting a response signal in the downlink. For example, studies of a method of associating RB numbers of uplink RBs to allocate uplink data with channel numbers of PHICHs one-on-one are underway (for example, see Patent Document 2). By this means, each mobile station can determine PHICHs for the mobile station according to uplink RB allocation information from a base station even if each mobile station is not separately reported PHICH allocation information, so that it is possible to reduce the amount of signaling. Here, when uplink data is allocated to a plurality of RBs, the PHICH associated with the RB of the smallest RB number is used.

Moreover, a PHICH grouping method is used to further reduce the total amount of resources for PHICHs by grouping a plurality of RBs into a plurality of groups every plurality of consecutive RBs and associating every group with one PHICH.

Non-Patent Document 1: 3GPP RAN WG1 Meeting document, R1-080683, “Frequency Hopping Pattern for PUSCH”, Samsung, LGE, NEC, Qualcomm, ZTE
Non-Patent Document 2: 3GPP RAN WG1 Meeting document, R1-070932, “Assignment of Downlink ACK/NACK channel”, Panasonic

### DISCLOSURE OF INVENTION

### Problems to be Solved by the Invention

Use of combination of the FH retransmission method and the PHICH grouping method, which are being studied in recent years, is possible. Now, an exemplary RB allocation will be described in detail. In the following descriptions, a base station receives uplink data transmitted from each mobile station using any of uplink RBs #1 to #10 shown in FIG. 1. Then, the base station allocates a response signal (ACK signal or NACK signal) to the uplink data, to PHICHs #1 to #5 shown in FIG. 1 and transmits the result to each mobile station. Here, as shown in FIG. 1, RB #1 to RB #10 are grouped into a plurality of groups for every two consecutive RBs, and each group of RBs is associated with one PHICH. For example, as shown in FIG. 1, RB #1 and RB #2 are grouped, and PHICH #1 is associated with the group composed of RB #1 and RB #2. Likewise, RB #3 and RB #4 are grouped, and PHICH #2 is associated with the group composed of RB #3 and RB #4. The same applies to RB #5 to RB #10.

FIG. 2 shows an FH pattern in which RB #1 to RB #10 are blocked into a plurality of blocks and a plurality of RBs are hopped per block. To be more specific, uplink RB #1 to RB #10 shown in FIG. 2 are blocked for every five RBs and divided into one block composed of RB #1 to RB #5 and the other block composed of RB #6 to RB #10. Then, RB #1 to RB #5 constituting one block at the time of the first transmission are hopped to RB #6 to RB #10 at the time of retransmission, respectively. Likewise, RB #6 to RB #10 constituting one block at the time of the first transmission are hopped to RB #1 to RB #5 at the time of retransmission, respectively.

For example, a case will be described here where, at the time of the first transmission, uplink data from mobile station 1 is allocated to RB #1 to RB #4 and uplink data from mobile station 2 is allocated to #10 as shown in the upper section of FIG. 3. As shown in the upper section of FIG. 3, the RB of the smallest RB number is RB #1, among RB #1 to #4 to which uplink data from mobile station 1 is allocated. Then, a response signal to the uplink data from mobile station 1 at the time of the first transmission is allocated to PHICH #1 according to the association shown in FIG. 1. Likewise, a response signal to the uplink data from mobile station 2 at the time of the first transmission is allocated to PHICH #5 according to the association shown in FIG. 1.

Here, when uplink data has an error and needs to be retransmitted, uplink data from mobile station 1 at the time of retransmission is allocated to RB #6 to RB #9 in accordance with the FH pattern shown in FIG. 2, as shown in the lower section of FIG. 3. Meanwhile, uplink data from mobile station 2 at the time of retransmission is allocated to RB #5 in accordance with the FH pattern shown in FIG. 2. Here, as shown in the lower section of FIG. 3, the RB of the smallest RB number is RB #6, among RB #6 to RB #9 to which uplink data from mobile station 1 is allocated. Then, a response signal to the uplink data from mobile station 1 at the time of retransmission is allocated to PHICH #3 associated with RB #6. Likewise, a response signal to the uplink data from mobile station 2 at the time of retransmission is allocated to PHICH #3 associated with RB #5. That is, although the response signal to the uplink data from mobile station 1 at the time of the first transmission and the response signal to the uplink data from mobile station 2 at the time of the first transmission are allocated to different PHICHs, a response signal to uplink data from mobile station 1 and a response signal to uplink data from mobile station 2 are allocated to the same PHICH #3 at the time of retransmission. Therefore, a PHICH collision occurs between mobile stations.

Next, FIG. 4 shows an FH pattern to mirror a plurality of RBs. To be more specific, as for uplink RB #1 to RB #10 shown in FIG. 4, an RB of a smaller RB number is hopped to an RB of a larger RB number, For example, RB #1 at the time of the first transmission is hopped to RB #10 at the time of retransmission. Likewise, RB #2 at the time of the first transmission is hopped to RB #9 at the time of retransmission. The same applies to RB #3 to RB #10.

For example, a case will be described here where uplink data from mobile station 1 is allocated to RB #1 to RB #3 and uplink data from mobile station 2 is allocated to RB #4 at the time of the first transmission, as shown in the upper section of FIG. 5. As shown in the upper section of FIG. 5, the RB of the smallest RB number is RB #1, among RB #1 to RB #3 to which uplink data from mobile station 1 is allocated. Therefore, a response signal to the uplink data from mobile station 1 at the time of the first transmission is allocated to PHICH #1 according to the association shown in FIG. 1. Likewise, a response signal to the uplink data from mobile station 2 at the time of the first transmission is allocated to PHICH #2 in accordance with the association shown in FIG. 1.

Here, when uplink data has an error and needs to be retransmitted, the uplink data from mobile station 1 at the time of retransmission is allocated to RB #10 to RB #8 in accordance with the FR pattern shown in FIG. 4, as shown in the lower section of FIG. 5. Meanwhile, uplink data from mobile station 2 is allocated to RB #7 in accordance with the FH pattern shown in FIG. 4. As shown in the lower section of FIGS, the RB of the smallest RB number is RB #8, among RB #10 to RB #8 to which uplink data from mobile station 1 is allocated. Therefore, a response signal to the uplink data from mobile station 1 at the time of retransmission is allocated to PHICH #4 associated with RB #8. Likewise, a response signal to the uplink data from mobile station 2 at the time of retransmission is allocated to PHICH #4 associated with RB #7. That is, despite the fact that response signals to uplink data from mobile station 1 and mobile station 2 at the time of the first transmission are allocated to different PHICHs, the response signal to uplink data from mobile station 1 and the response signal to uplink data from mobile station 2 are allocated to the same PHICH #4 at the time of retransmission. Therefore, a PHICH collision occurs between mobile stations.

As described above, when combination of the FH retransmission method and the PHICH grouping method is used, a PHICH collision is likely to occur between mobile stations at the time of retransmission depending on the RBs to which uplink data is allocated.

It is therefore an object of the present invention to provide a radio communication base station apparatus and a radio communication method allowing prevention of a PHICH collision between the mobile stations when combination of the FH retransmission method and the PHICH grouping method is used.

### Means for Solving the Problem

The radio communication base station apparatus according to the present invention is used in a radio communication system in which a plurality of resource blocks used to allocate uplink data are blocked into a plurality of blocks every M consecutive resource blocks (M is a natural number) and grouped into a plurality of groups every N consecutive resource blocks (N is a natural number), the radio communication base station apparatus adopts a configuration to include: an extracting section that extracts uplink data from the plurality of resource blocks every plurality of radio communication mobile station apparatuses in accordance with a hopping pattern to hop the plurality of resource blocks for every the plurality of blocks; and a mapping section that maps a plurality of control channels to which a response signal to the uplink data is allocated, to downlink resources, in accordance with associations between the plurality of groups and the plurality of control channels, wherein M is a natural number multiple of N.

### Advantageous Effects of Invention

According to the present invention, it is possible to prevent a PHICH collision between the mobile stations when combination of the FH retransmission method and the PHICH grouping method is used.

### BRIEF DESCRIPTION OF DRAWINGS

FIG. 1 is a drawing showing association between a plurality of uplink RBs and a plurality of PHICHs;

FIG. 2 is a drawing showing an FH pattern in which a plurality of RBs are blocked into a plurality of blocks;

FIG. 3 is a drawing showing an exemplary RB allocation when the FH pattern in which a plurality of RBs are blocked into a plurality of blocks is used;

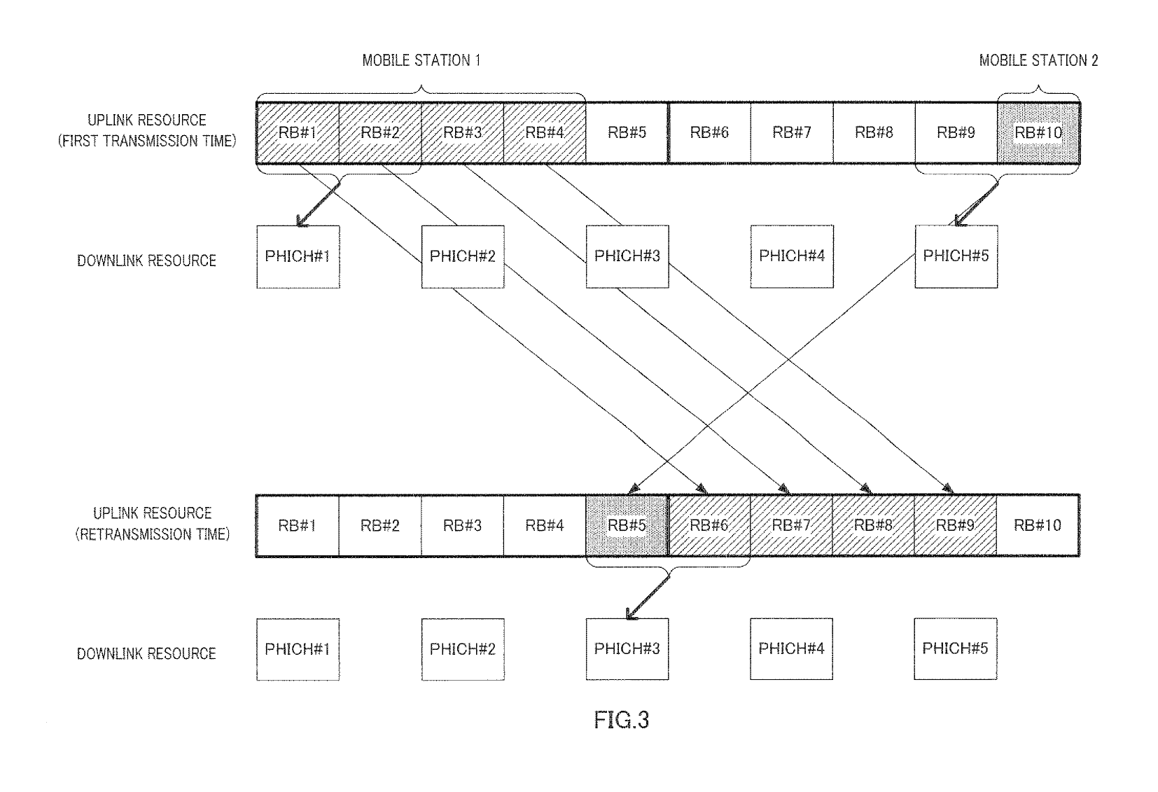

FIG. 4 is a drawing showing an FH pattern in which a plurality of RBs are mirrored;

FIG. 5 is a drawing showing an exemplary RB allocation when the FH pattern in which a plurality of RBs are mirrored;

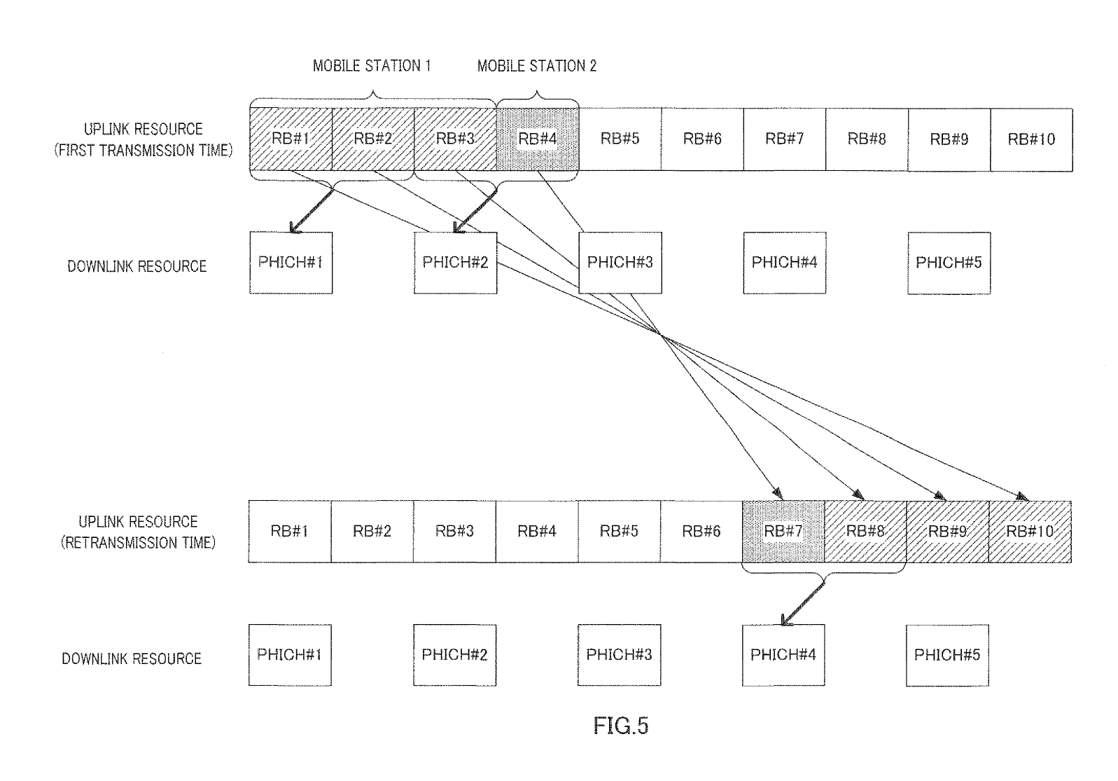

FIG. 6 is a block diagram showing a configuration of a base station according to Embodiment 1 of the present invention;

FIG. 7 is a drawing showing an FH pattern according to Embodiment 1 of the present invention (M is twice as large as N);

FIG. 8 is a drawing showing an exemplary RB allocation according to Embodiment 1 of the present invention;

FIG. 9 is a drawing showing an FH pattern according to Embodiment 1 of the present invention (M and N are the same number);

FIG. 10 is a drawing showing an exemplary RB allocation according to Embodiment 1 of the present invention;

FIG. 11 is a drawing showing an exemplary RB allocation according to Embodiment 2 of the present invention;

FIG. 12 is a drawing showing association between a plurality of uplink RBs and a plurality of PHICHs according to Embodiment 3 of the present invention; and

FIG. 13 is a drawing showing an exemplary RB allocation according to Embodiment 3 of the present invention.

### BEST MODE FOR CARRYING OUT THE INVENTION

Now, embodiments of the present invention will be described in detail with reference to the accompanying drawings. In the following descriptions, downlink data is transmitted using ODFM (orthogonal frequency division multiplexing) and uplink data is transmitted using SC-FDMA.

### Embodiment 1

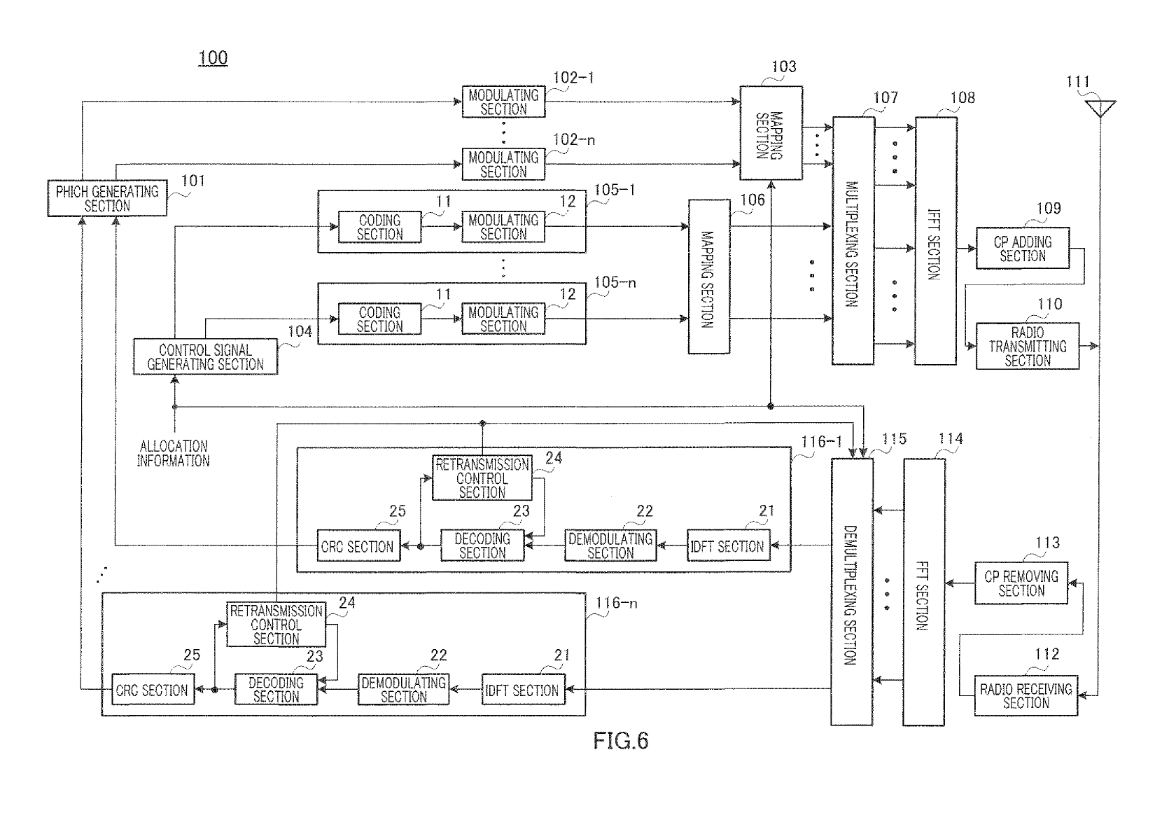

The configuration of base station 100 according to the present embodiment is shown in FIG. 6. In the following descriptions, base station 100 is used in a radio communication system in which a plurality of RBs used to allocate uplink data are blocked into a plurality of blocks every M consecutive RBs (M is a natural number) and grouped into a plurality of groups every N consecutive RBs (N is a natural number).

Here, to avoid complicated explanation, FIG. 6 shows components relating to uplink data reception and components relating to downlink transmission of a response signal to the uplink data, which are closely related to the present invention, and the illustration and explanation of the components associated with downlink data transmission will be omitted.

Base station 100 has PHICH modulating sections 102-1 to 102-n; SCCH (shared control channel) coding and modulating sections 105-1 to 105-n each composed of coding section 11 and modulating section 12; and data channel demodulating and decoding sections 116-1 to 116-n each composed of IDFT (inverse discrete Fourier transform) section 21, demodulating section 22, decoding section 23, retransmission control section 24 and CRC (cyclic redundancy check) section 25, which are provided corresponding to the number n of mobile stations 1-n that can communicate with base station 100.

PHICH generating section 101 receives, as input, a response signal (ACK signal or NACK signal) to uplink data from each mobile station. PHICH generating section 101 generates, for each mobile station, PHICHs for transmitting a response signal to uplink data from each mobile station, and outputs the generated PHICHs to each corresponding modulating section 102.

Each of modulating sections 102-1 to 102-n performs transform processing on a response signal (ACK signal or NACK signal) per mobile station, which is transmitted on PHICHs per mobile station and outputs a modulated response signal to mapping section 103.

Mapping section 103 receives in advance, as input, PHICH grouping information indicating the associations between a plurality of groups into which a plurality of uplink RBs to allocate uplink data are grouped and a plurality of PHICHs. Mapping section 103 maps a response signal to uplink data from each mobile station, to one of a plurality of subcarriers constituting an OFDM symbol based on allocation information indicating, to each mobile station, RBs used to allocate uplink data from each mobile station, and PHICH grouping information. That is, mapping section 103 maps a plurality of PHICHs to which a response signal to uplink data per mobile station is allocated, to one of a plurality of subcarriers constituting an OFDM symbol. In addition, when uplink data of one mobile station is allocated to a plurality of RBs, mapping section 103 uses the PHICH associated with the RB of the smallest RB number. Mapping processing in mapping section 103 will be described in detail later.

Allocation information indicating RBs to allocate uplink data from each mobile station, to each mobile station is inputted to control signal generating section 104. Control signal generating section 104 generates, for each mobile station, a control signal including allocation information and outputs the control signal to each corresponding coding section 11.

In each of coding and modulating section 105-1 to 105-n, coding section 11 performs coding processing on a control signal from each mobile station, which is transmitted on SCCHs per mobile station, and modulating section 12 performs modulating processing on the encoded control signal and outputs the result to mapping section 106.

Mapping section 106 maps a control signal directed to each mobile station, to one of subcarriers constituting an OFDM symbol and outputs the result to multiplexing section 107, That is, mapping section 106 maps a plurality of SCCHs per mobile station to one of a plurality of subcarriers constituting an OFDM symbol.

Multiplexing section 107 time-multiplexes the response signal inputted from mapping section 103 and the control signal inputted from mapping section 106 and outputs the result to IFFT (inverse fast Fourier transform) section 108.

IFFT section 108 performs the IFFT on the response signal or control signal mapped to a plurality of subcarriers to generate an OFDM symbol.

CP (cyclic prefix) adding section 109 adds the same signal as the end part of the OFDM symbol to the beginning of the OFDM symbol as a CP.

Radio transmitting section 110 performs transmission processing, including D/A conversion, amplification, up-conversion and so forth, on the OFDM symbol with a CP, and transmits the result from antenna 111 to each mobile station.

Meanwhile, radio receiving section 112 receives n SC-FDMA symbols transmitted at the same time from maximum n number of mobile stations via antenna 111 and performs reception processing, including down-conversion, AID conversion and so forth, on these SC-FDMA symbols.

CP removing section 113 removes the CP from the OFDM symbol after reception processing.

FFT (fast Fourier transform) section 114 obtains a frequency domain multiplexed signal per mobile station by performing the FFT on the OFDM symbol without a CP. Here, each mobile station transmits a signal using different RBs from each other.

Demultiplexing section 115 receives in advance, as input, an FH pattern in which a plurality of RBs to allocate uplink data from a plurality of mobile stations are hopped every plurality of blocks. Demultiplexing section 115 demultiplexes uplink data into data per mobile station by extracting, for each mobile station, uplink data from a plurality of RBs to which uplink data is allocated, in accordance with allocation information reported to each mobile station, the number of times of retransmissions inputted from retransmission control section 24, and the FH pattern at the time of retransmission. Then, demultiplexing section 115 outputs uplink data per mobile station to corresponding one of demodulating and coding sections 116-1 to 116-n. Demultiplexing processing in demultiplexing section 115 will be described in detail later.

In each of demodulating and decoding sections 116-1 to 116-n, IDFT section 21 performs IDFT processing on the uplink data after the FFT to transform the data to a time domain signal. Each demodulating section 22 performs demodulating processing on the uplink data after the IDFT, and each decoding section 23 performs decoding processing on the uplink data after demodulating or the uplink data after combining packets. In addition, each retransmission control section 24 performs packet combining on the demodulated uplink data depending on the number of times of retransmissions and outputs the uplink data after packet combining (received bit likelihood) to decoding section 23. In addition, each retransmission control section 24 counts the number of times of retransmissions every time uplink data at the time of retransmission is inputted, and outputs the number of times of retransmissions to demultiplexing section 115. In addition, each CRC section 25 performs CRC detection on the decoded uplink data, and, if the uplink data has no error, generates an ACK signal, or, if the uplink data has an error, outputs a NACK signal to PHICH generating section 101 as a response signal.

Meanwhile, the same PHICH grouping information and FH pattern as in base station 100 are broadcast to each mobile station in advance by a broadcast channel. When receiving allocation information indicating uplink RBs from the base station to each mobile station, each mobile station transmits transmission data, i.e, uplink data, to the base station according to the allocation information. In addition, each mobile station receives a response signal allocated to the PHICHs associated with the RBs allocated for the mobile station in accordance with RB and PHICH grouping information used in the previous transmission of uplink data. Here, for each mobile station, which PHICH is associated with which downlink resource, is designated by a higher layer or determined in advance. Then, when the response signal is an ACK signal, each mobile station waits until the base station transmits allocation information for the mobile station, in order to transmit the next uplink data. On the other hand, when the response signal is a NACK signal, each mobile station retransmits uplink data. In addition, when retransmitting uplink data, each mobile station allocates the previously transmitted uplink data to uplink RBs in accordance with the FH pattern.

Next, mapping processing in mapping section 103 and demultiplexing processing in demultiplexing section 115 will be described in detail.

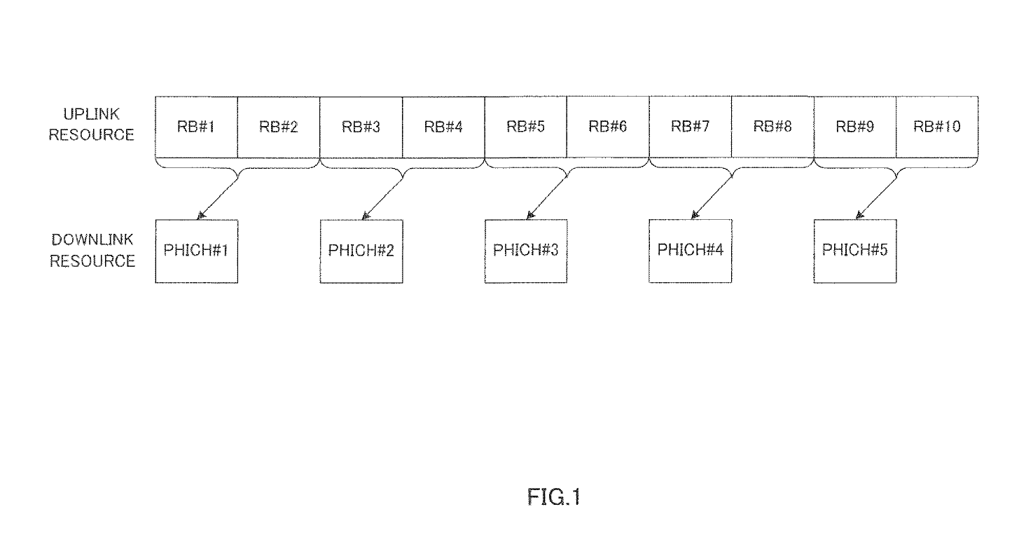

With the present embodiment, base station 100 receives uplink data transmitted from each mobile station using one of uplink RB #1 to uplink RB #10 shown in FIG. 1. Then, base station 100 allocates a response signal (ACK signal or NACK signal) to the uplink data, to PHICH #1 to PHICH #5 shown in FIG. 1 and transmits the result to each mobile station.

In addition, as shown in FIG. 1, RB #1 to RB #10 are grouped every N consecutive RBs (N is a natural number), and each group of RBs is associated with one PHICH. To be more specific, when N is two (N=2), RB #1 and RB #2 are grouped, and PHICH #1 is associated with the group composed of RB #1 and RB #2, as shown in FIG. 1. Likewise, RB #3 and RB #4 are grouped and PHICH #2 is associated with the group composed of RB #3 and RB #4. The same applies to RB #5 to RB #10.

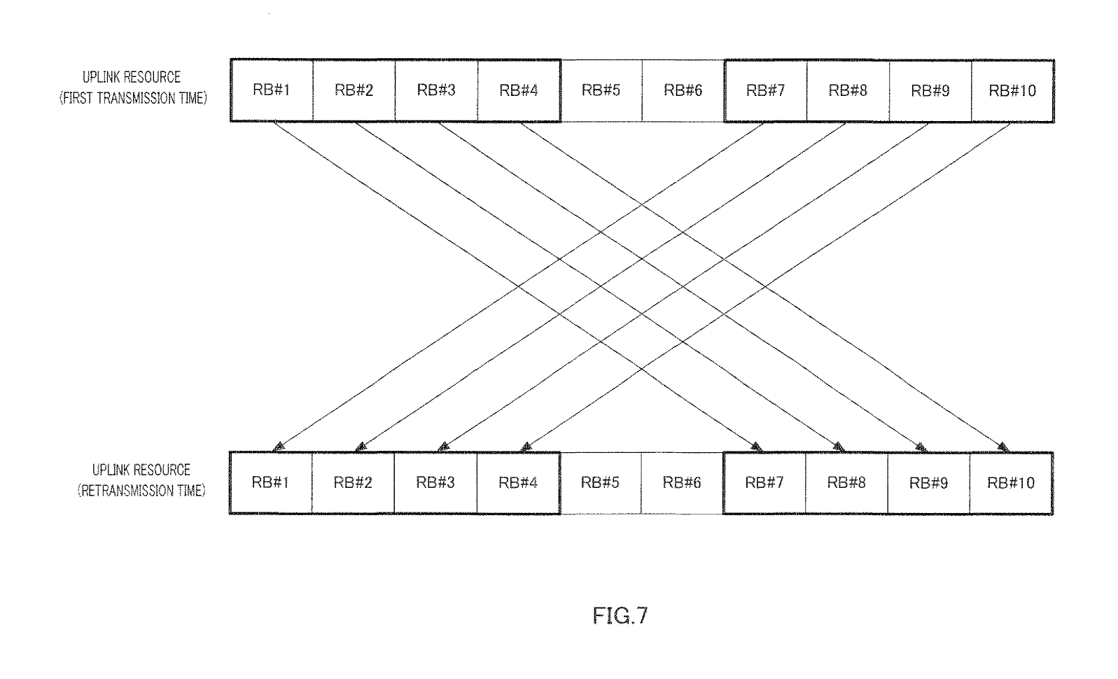

In addition, with the present embodiment, RB #1 to RB #10 shown in FIG. 1 are blocked into a plurality of blocks every M consecutive RBs (M is a natural number), and uplink data is allocated to RBs according to the FH pattern in which each of RBs is hopped per block. With the FH pattern according to the present embodiment, the number (M) of RBs blocked into one block is a natural number multiple of the number (N) of RBs grouped into one group. That is, with the FH pattern according to the present embodiment, frequency hopping is performed every block composed of the number (M) of RBs, which is a natural number multiple of the number (N) of RBs using the same PHICH. Here, the number of RBs grouped into one group is two, so that N is two (N=2). Now, hopping methods 1 and 2 will be described.

<Hopping Method 1 (FIG. 7)>

In the FH pattern of this hopping method, the number (M) of RBs blocked into one block is twice as large as the number (N) of RBs grouped into one group. That is, the number (M) of RBs blocked into one block is four (=N×2=4).

The FH pattern is shown in FIG. 7 where the number (M) of RBs blocked into one block is four.

As shown in FIG. 7, uplink RB #1 to RB #10 are blocked into a plurality of blocks for every four RBs. To be more specific, as shown in FIG. 7, four RBs from RB #1 to RB #4 are blocked into one block and four RBs from RB #7 to RB #10 are blocked into one block. Then, as shown in FIG. 7, RB #1 to RB #4 constituting one block at the time of the first transmission are hopped to RB #7 to RB #10 at the time of retransmission, respectively. Likewise, RB #7 to RB #10 constituting one block at the time of the first transmission are hopped to RB #1 to RB #4 at the time of retransmission, respectively.

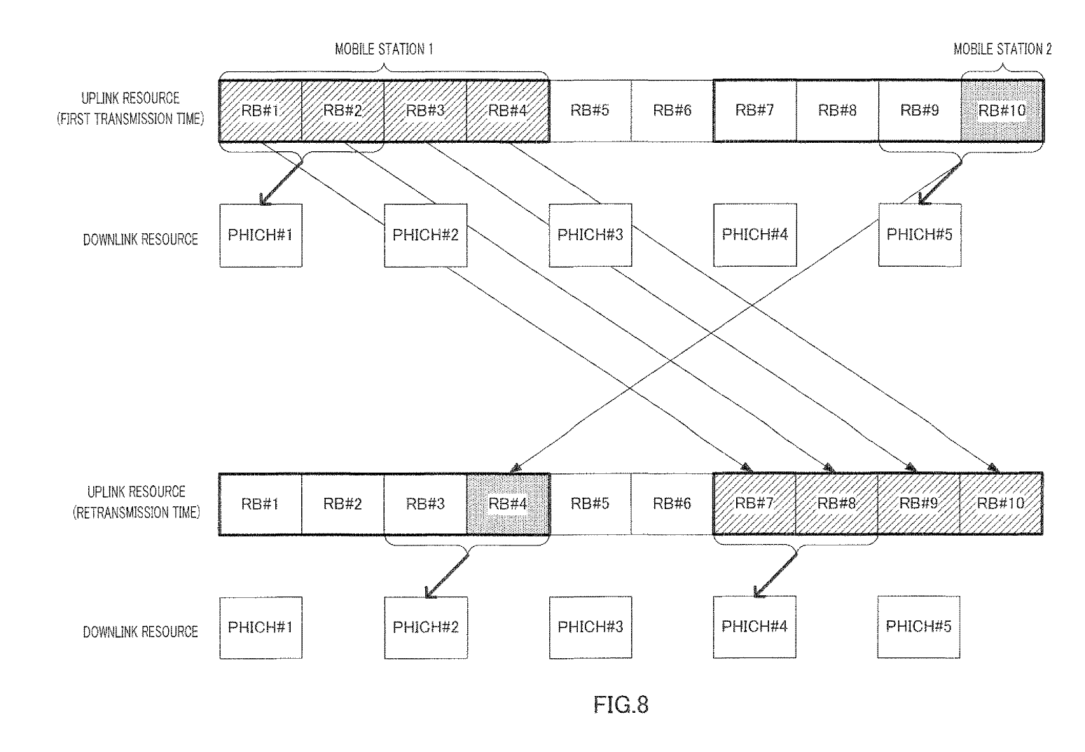

Next, a case will be described here where, for example, uplink data from mobile station 1 is allocated to RB #1 to RB #4 and uplink data from mobile station 2 is allocated to RB #10 at the time of the first transmission as shown in the upper section of FIG. 8. That is, allocation information reported from base station 100 to each mobile station indicates that uplink data from mobile station 1 is allocated to RB #1 to RB #4 and uplink data from mobile station 2 is allocated to RB #10.

First, demultiplexing section 115 specifies, from inputted allocation information, that uplink data from mobile station 1 is allocated to RB #1 to RB #4 shown in the upper section of FIG. 8 and that uplink data from mobile station 2 is allocated to RB #10 shown in the upper section of FIG. 8. Then, demultiplexing section 115 extracts the uplink data from each of mobile station 1 and mobile station 2 and outputs the uplink data per mobile station to respectively corresponding to demodulating and decoding section 116-1 to 116-n.

Here, assume that that the uplink data from each of mobile station 1 and mobile station 2 has an error, and therefore it is necessary to feed a NACK signal back to each mobile station as a response signal to the uplink data from each mobile station. In this case, mapping section 103 maps a response signal (NACK signal) to uplink data from each mobile station, to uplink resources in which PHICHs are provided, which are associated with RBs to allocate uplink data at the time of retransmission from each mobile station. Here, when uplink data from one mobile station is allocated to a plurality of RBs, mapping section 103 uses the PHICH associated with the RB of the smallest RB number, among a plurality of RBs. To be more specific, as shown in the upper section of FIG. 8, the RB of the smallest RB number is RB #1, among RB #1 to RB #4 to which the uplink data from mobile station 1 at the time of the first transmission is allocated. Therefore, mapping section 103 maps a response signal to the uplink data from mobile station 1 at the time of the first transmission to the downlink resource in which PHICH #1 associated with RB #1 is provided. Likewise, as shown in the upper section of FIG. 8, the RB to which the uplink data from mobile station 2 at the time of the first transmission is allocated is RB #10. Therefore, mapping section 103 maps a response signal to the uplink data from mobile station 2 at the time of the first transmission, to the downlink resource in which PHICH #5 associated with RB #10 is provided.

Mobile station 1 and mobile station 2 respectively receive response signals (NACK signals) from base station 100 and then retransmit uplink data. Here, each mobile station allocates uplink data at the time of retransmission to uplink RBs according to the FH pattern shown in FIG. 7. That is, mobile station 1, which allocated uplink data to RB #1 to RB #4 at the time of the first transmission, allocates uplink data at the time of retransmission to RB #7 to RB #10, as shown in the lower section of FIG. 8. Likewise, mobile station 1, which allocated uplink data to RB #10 at the time of the first transmission, allocates uplink data at the time of retransmission to RB #4, as shown in the lower section of FIG. 8.

Then, demultiplexing section 115 which received, as input, the uplink data at the time of retransmission from each mobile station, extracts the uplink data allocated to RB #7 to RB #10 from mobile station 1 at the time of retransmission and the uplink data allocated to RB #4 from mobile station 2 at the time of retransmission, in accordance with the FH pattern shown in FIG. 7 in the same way as in each mobile station.

In addition, mapping section 103 maps a response signal (ACK signal or NACK signal) to uplink data at the time of retransmission from each mobile station to downlink resources in which PHICHs are provided, in the same way as at the time of the first transmission. To be more specific, as shown in the lower section of FIG. 8, the RB of the smallest RB number is RB #7, among RB #7 to RB #10 to which uplink data from mobile station 1 at the time of retransmission is allocated. Then, mapping section 103 maps a response signal to the uplink data from mobile station 1 at the time of retransmission, to the downlink resource in which PHICH #4 associated with RB #7 is provided. Likewise, as shown in the lower section of FIG. 8, the RB to which the uplink data from mobile station 2 at the time of retransmission is allocated is RB #4. Therefore, mapping section 103 maps a response signal to the uplink data from mobile station 2 at the time of retransmission, to the downlink resource in which PHICH #2 associated with RB #4 is provided.

By this means, at the time of retransmission, the response signal to uplink data from mobile station 1 and the response signal to uplink data from mobile station 2 are transmitted using different PHICHs, so that a PHICH collision does not occur between the mobile stations.

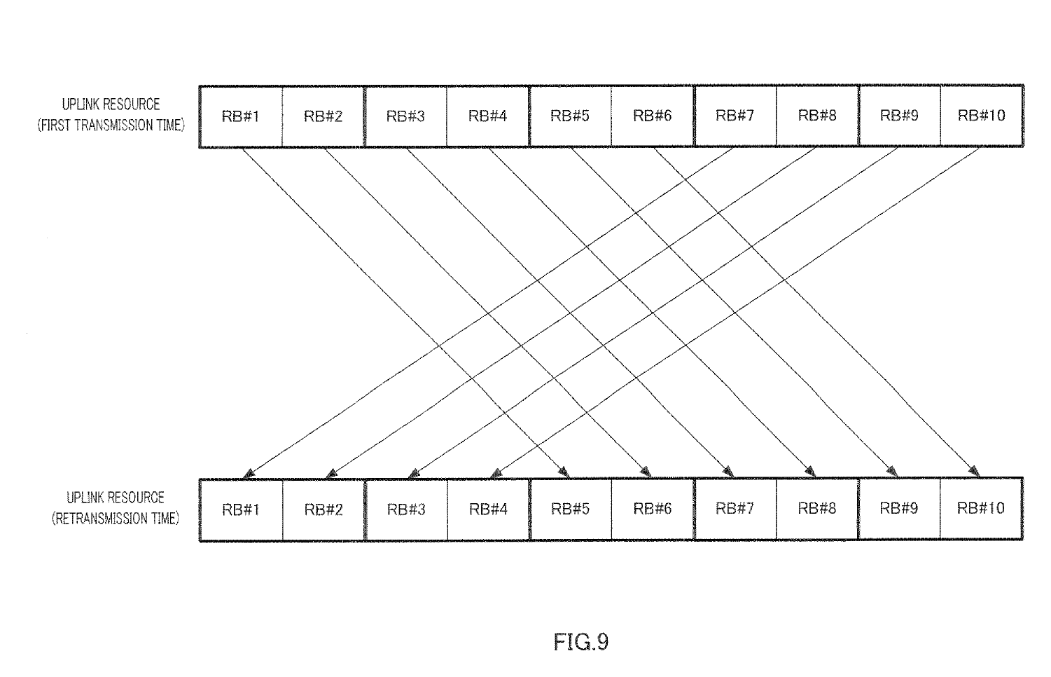

As described above, according to this hopping method, mobile stations using different PHICHs at the time of the first transmission, do not use the same PHICH at the time of retransmission, so that it is possible to prevent a PHICH collision between the mobile stations.

<Hopping Method 2 (FIG. 9)>

In the FH pattern of this hopping method, the number (M) of RBs blocked into one block is one time as large as the number (N) of RBs grouped into one group. That is, the number (M) of RBs blocked into one block is the same as the number (N) of RBs grouped into one group. Here, N is two (N=2), so that the number (M) of RBs blocked into one block is two (=N×1=2).

The FH pattern is shown in FIG. 9 in a case in which the number (M) of RBs blocked into one block is two.

As shown in FIG. 9, uplink RB #1 to RB #10 are blocked into a plurality of blocks for every two RBs. To be more specific, as shown in FIG. 9, two RBs, RB #1 and RB #2, are blocked into one block. Likewise, two RBs, RB #3 and RB #4, are blocked into one block. The same applies to RB #5 to RB #10.

Then, as shown in FIG. 9, RB #1 and RB #2 constituting one block at the time of the first transmission are hopped to RB #5 and RB #6, respectively, at the time of retransmission. Likewise, RB #3 and RB #4 constituting one block at the time of the first transmission are hopped to RB #7 and RB #8, respectively, at the time of retransmission. The same applies to RB #5 to RB #10.

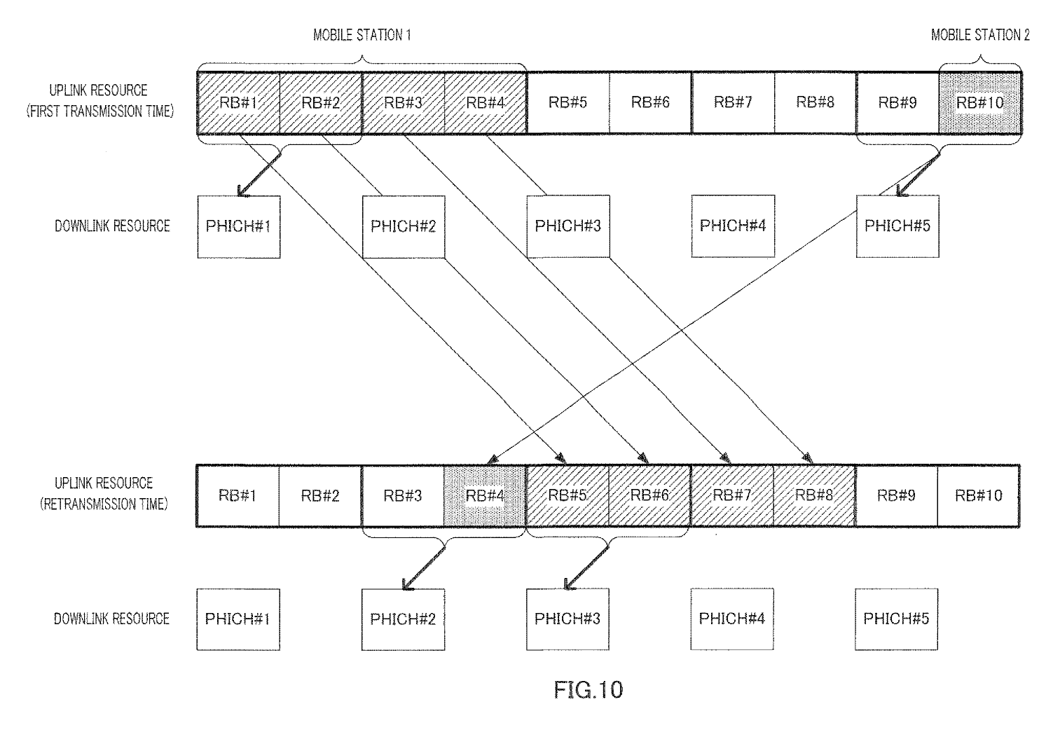

Next, for example, a case will be described here where, as shown in the upper section of FIG. 10, uplink data from mobile station 1 is allocated to RB #1 to RB #4 and uplink data from mobile station 2 is allocated to RB #10 at the time of the first transmission in the same way as in hopping method 1.

Demultiplexing section 115, first, specifies the uplink data (RB #1 to RB #4 shown in the upper section of FIG. 10) from mobile station 1 and the uplink data (RB #10 shown in the upper section of FIG. 10) from mobile station 2, and extracts the uplink data per mobile station in the same way as in hopping method 1.

Here, assume that that the uplink data from each of mobile station 1 and mobile station 2 has an error, and therefore it is necessary to feed a NACK signal back to each mobile station as a response signal to uplink data from each mobile station. In this case, as shown in the upper section of FIG. 10, mapping section 103 maps the response signal to the uplink data from mobile station 1 at the time of the first transmission, to the downlink resource in which PHICH #1 is provided, and maps the response signal to the uplink data from mobile station 2 at the time of the first transmission to the downlink resource in which PHICH #5 is provided, in the same way as in hopping method 1.

Mobile station 1 and mobile station 2 respectively receive response signals (NACK signals) from base station 100 and then retransmit uplink data. Here, each mobile station allocates uplink data at the time of retransmission to uplink RBs according to the FH pattern shown in FIG. 9. That is, mobile station 1, which allocated uplink data to RB #1 to #4 at the time of the first transmission, allocates the uplink data at the time of retransmission to RB #5 to RB #8, as shown in the lower section of FIG. 10. Likewise, mobile station 2, which allocated the uplink data to RB #10 at the time of the first transmission, allocates the uplink data at the time of retransmission to RB #4 as shown in the lower section of FIG. 10.

Then, after receiving, as input, the uplink data at the time of retransmission from each mobile station, demultiplexing section 115 extracts the uplink data allocated to RB #5 to RB #8 from mobile station 1 at the time of retransmission and the uplink data allocated to RB #4 from mobile station 2 at the time of retransmission, in accordance with the FH pattern shown in FIG. 9 in the same way as in each mobile station.

In addition, mapping section 103 maps a response signal (ACK signal or NACK signal) to the uplink data at the time of retransmission from each mobile station, to the downlink resources in which PHICHs are provided, in the same way as at the first transmission. To be more specific, as shown in the lower section of FIG. 10, the RB of the smallest RB number is RB #5, among RB #5 to RB #8 to which the uplink data at the time of retransmission from mobile station 1 is allocated. Therefore, mapping section 103 maps a response signal to the uplink data from mobile station 1 at the time of retransmission, to the downlink resource in which PHICH #3 associated with RB #5 is provided. Likewise, as shown in the lower section of FIG. 10, the RB to which the uplink data from mobile station 2 at the time of retransmission is allocated is RB #4. Then, mapping section 103 maps a response signal to the uplink data from mobile station 2 at the time of retransmission, to the downlink resource in which PHICH #2 associated with RB #4 is provided.

By this means, at the time of retransmission, a response signal to uplink data from mobile station 1 and a response signal to uplink data from mobile station 2 are transmitted using different PHICHs in the same way as in hopping method 1, so that a PHICH collision between the mobile stations does not occur in the same way as in hopping method 1.

As described above, it is possible to prevent a PHICH collision between the mobile stations by using this hopping method in the same way as in hopping method 1.

Hopping methods 1 and 2 have been described.

As described above, according to the present embodiment, the number (M) of RBs blocked into one block is a natural number multiple of the number (N) of RBs grouped into groups each associated with one PHICH in an FH pattern. In other words, the number (M) of RBs blocked into one block can be divided by the number (N) of RBs grouped into groups each associated with one PHICH. That is, since one block is composed of a plurality of groups each associated with one PHICH, so that hopping a plurality of RBs on a per block basis is equivalent to hopping a plurality of

RBs in units of groups each associated with one PHICH. That is, each RB is hopped while the relationship between N RBs constituting one group and the PHICH associated with that group is maintained. In other words, a plurality of RBs are hopped per block (per group) while one PHICH associated with a group of RBs is hopped in synchronization with the hopping of a plurality of RBs. That is, this is equivalent to synchronization of an FH pattern to hop a plurality of RBs and an FH pattern to hop a plurality of PHICHs associated with RBs per group, based on the assumption of a hopping pattern to hop PHICHs. By this means, if different PHICHs are used between mobile stations at the time of the first transmission, different PHICHs are also used at the time of retransmission. That is, a PHICH collision does not occur between different mobile stations at the time of retransmission as long as RBs are allocated to prevent a PHICH collision between different mobile stations at the time of the first transmission.

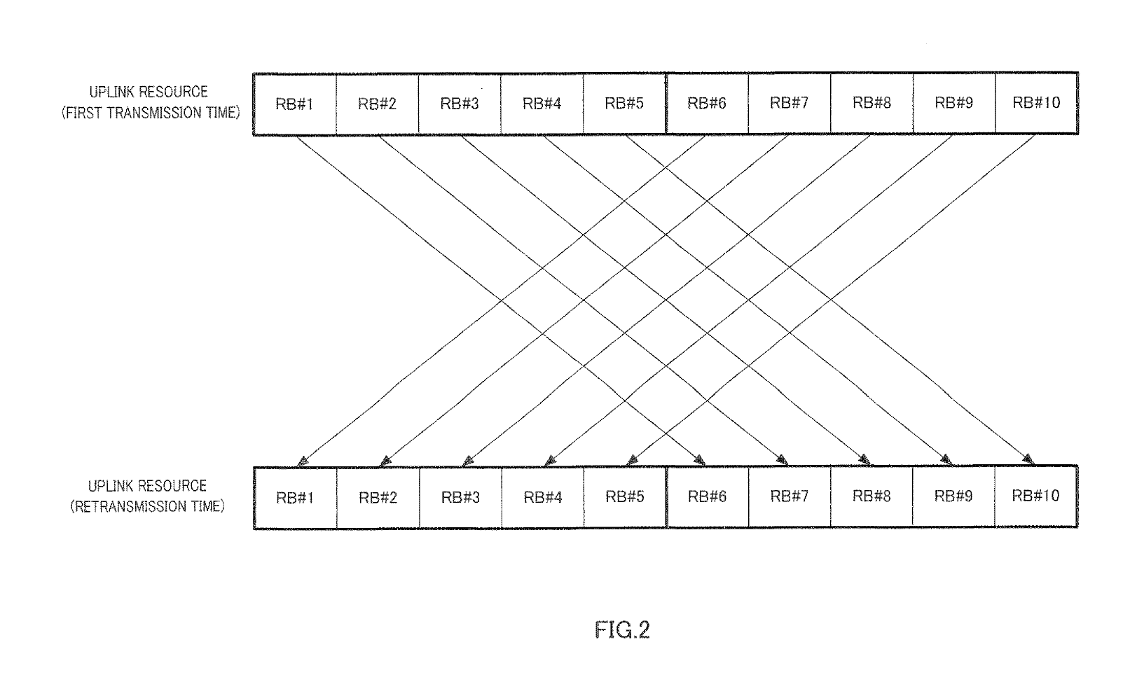

In addition, now, a conventional FH pattern (FIG. 2) and the FH pattern (9) according to the present embodiment will be compared. In the FH pattern shown in FIG. 2, the RB (for example, RB #1 shown in FIG. 2) at the time of the first transmission is five RBs apart from the RB (for example, RB #6 shown in FIG. 2) hopped at the time of retransmission. By contrast with this, in the FH pattern shown in FIG. 9, the RB (for example, RB #1 shown in FIG. 9) at the time of the first transmission is four RBs apart from the RB (for example, RB #5 shown in FIG. 9) hopped at the time of retransmission. That is, the FH pattern shown in FIG. 2 produces greater frequency diversity effect than the FH pattern shown in FIG. 9. However, when RBs are grouped into a plurality of groups every plurality of RBs and each group of RBs is associated with one PHICH, the number of mobile stations is expected to be reduced and the possibility that all RB #1 to RB #10 are used is low. Therefore, when there are RBs not allocated to other mobile stations, it is possible to increase the number of RBs to allocate a mobile station requiring uplink data allocation. By this means, even if the FH pattern shown in FIG. 9 is used, although the resulting frequency diversity effect is reduced as compared to the FH pattern shown in FIG. 2, it is possible to prevent deterioration of reception characteristics by increasing the number of RBs to allocate per mobile station. That is, it is possible to prevent PHICH collisions between mobile stations without deterioration of reception characteristics by using the FH pattern according to the present embodiment.

As described above, according to the present embodiment, the number (M) of RBs blocked into one block is a natural number multiple of the number (N) of RBs grouped into one group in an FH pattern. By this means, the associations between a PHICH and RBs constituting a group associated with the PHICH are maintained before and after hopping. By this means, if different PHICHs are used between mobile stations at the time of the transmission (before hopping), a PHICH collision does not occur between mobile stations at the time of retransmission (after hopping). Therefore, according to the present embodiment, when combination of the FH retransmission method and the PHICH grouping method is used, it is possible to prevent PHICH collisions between mobile stations.

Here, with the present embodiment, a case has been described where the number (M) of RBs blocked into one block is a natural number multiple of the number (N) of RBs grouped into one group. By contrast with this, however, according to the present invention, the number (N) of RBs grouped into one group may be calculated from the number (M) of RBs blocked into one block. In this case, it is possible to produce the same effect as in the present embodiment.

### Embodiment 2

With the present embodiment, a case will be described here where an FH pattern in which a plurality of RBs are mirrored is used.

Now, the present embodiment will be described in detail.

When uplink data from one mobile station is allocated to a plurality of RBs, mapping section 103 (FIG. 6) according to the present embodiment uses PHICHs associated with different RBs according to the number of times of retransmissions. To be more specific, when uplink data from one mobile station is allocated to a plurality of RBs, mapping section 103 uses the PHICH associated with the RB of the smallest RB number at the time of the first transmission in the same way as in Embodiment 1, but uses the PHICH associated with the RB of the largest RB number at the time of retransmission.

This will be described in detail below. In the present embodiment, base station 100 receives uplink data transmitted from each mobile station using any of uplink RB #1 to RB #10 shown in FIG. 1 in the same way as in Embodiment 1. Then, base station 100 provides a response signal (ACK signal or NACK signal) to the uplink data, to PHICHs #1 to #5 shown in FIG. 1, and transmits the result to the mobile station.

In addition, as shown in FIG. 1, RB #1 to RB #10 are grouped for every neighboring two RBs, and each group of RBs is associated with one PHICH in the same way as in Embodiment 1.

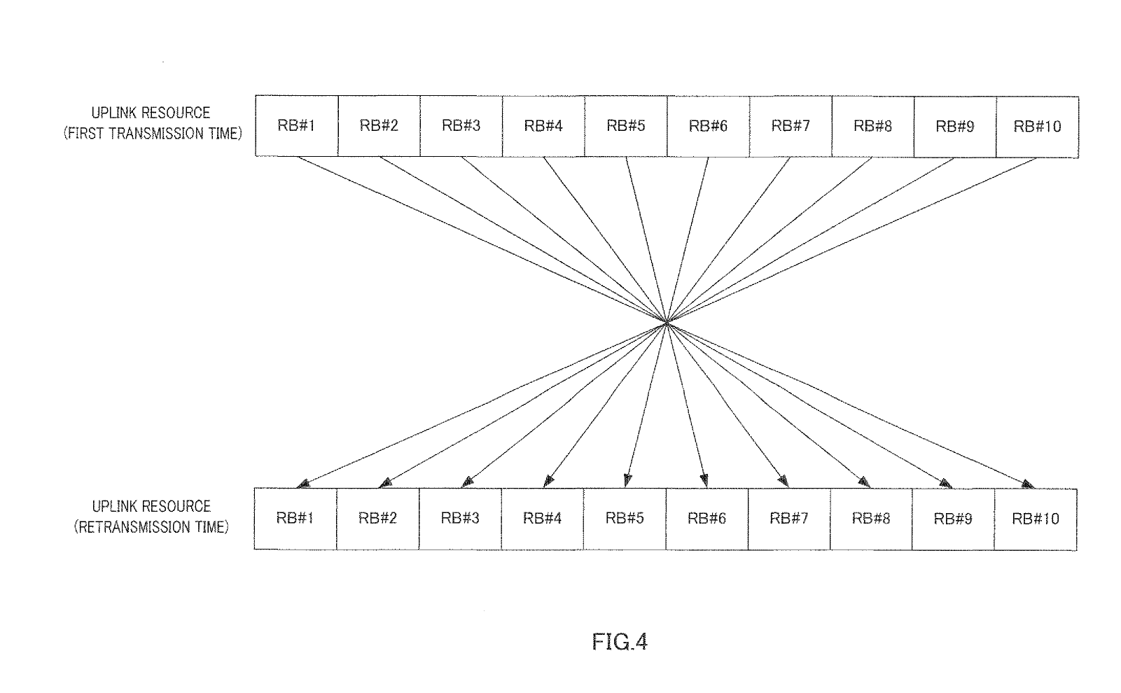

In addition, in the present embodiment, the FH pattern in which a plurality of RBs are mirrored as shown in FIG. 4 is used. That is, an RB of a smaller RB number at the time of the transmission is hopped to an RB of a larger number at the time of retransmission. To be more specific, RB #1 at the time of the first transmission is hopped to RB #10 at the time of retransmission as shown in FIG. 4. Likewise, RB #2 at the time of the first transmission is hopped to RB #9 at the time of retransmission. The same applies to RB #3 to RB #10.

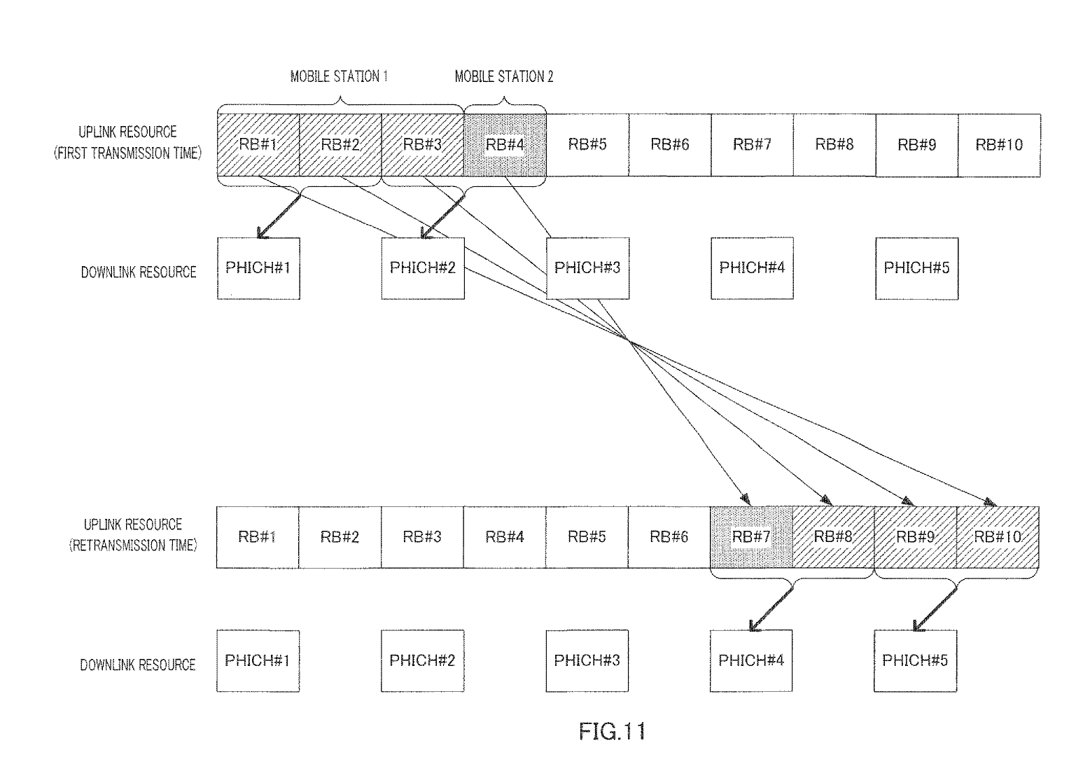

Next, a case will be described here where, for example, uplink data from mobile station 1 is allocated to RB #1 to #3 and uplink data from mobile station 2 is allocated to RB #4 at the time of the first transmission as shown in FIG. 11. That is, allocation information reported from base station 100 to each mobile station indicates that uplink data from mobile station 1 is RB #1 to #3 and uplink data from mobile station 2 is allocated to RB #4.

Demultiplexing section 115, first, specifies the uplink data (RB #1 to RB #3 shown in FIG. 11) from mobile station 1 and the uplink data (RB #4 shown in FIG. 11) from mobile station 2, and extracts the uplink data per mobile station in the same way as in Embodiment 1.

Here, assume that that the uplink data from each of mobile station 1 and mobile station 2 has an error, and therefore it is necessary to feed a NACK signal back to each mobile station as the response signal to the uplink data from each mobile station. In this case, when uplink data from one mobile station at the time of the first transmission is allocated to a plurality of RBs, mapping section 103 uses the PHICH associated with the RB of the smallest RB number in the same way as in Embodiment 1. To be more specific, as shown in the upper section of FIG. 11, the RB of the smallest RB number is RB #1, among RB #1 to RB #3 to which the uplink data from mobile station 1 at the time of the first transmission is allocated. Therefore, mapping section 103 maps the response signal to the uplink data from mobile station 1 at the time of the first transmission, to the downlink resource in which PHICH #1 associated with RB #1 is provided. In addition, as shown in the upper section of FIG. 11, mapping section 103 maps the response signal to the uplink data from mobile station 2 at the time of the first transmission, to the downlink resource in which PHICH #2 associated with RB #4 is provided.

Mobile station 1 and mobile station 2 respectively receive response signals (NACK signals) from base station 100 and then retransmit uplink data. Here, each mobile station allocates the uplink data at the time of retransmission to uplink RBs according to the FH pattern shown in FIG. 4. That is, mobile station 1, which allocated the uplink data to RB #1 to RB #3 at the time of the first transmission, allocates the uplink data at the time of retransmission to RB #10 to RB #8, as shown in the lower section of FIG. 11. Likewise, mobile station 2, which allocated the uplink data to RB #4, allocates the uplink data at the time of retransmission to RB #7 as shown in the lower section of FIG. 11.

Then, after receiving, as input, the uplink data at the time of retransmission from each mobile station, demultiplexing section 115 extracts the uplink data allocated to RB #10 to RB #8 from mobile station 1 at the time of retransmission and the uplink data allocated to RB 47 from mobile station 2 at the time of retransmission, in accordance with the FH pattern shown in FIG. 4 in the same way as in each mobile station.

In addition, mapping section 103 maps a response signal (ACK signal or NACK signal) to the uplink data at the time of retransmission from each mobile station, to downlink resources in which PHICHs are provided in the same way as at the time of the first transmission. Here, when uplink data at the time of retransmission from one mobile station is allocated to a plurality of RBs, mapping section 103 uses the PHICH associated with the RB of the largest RB number. To be more specific, as shown in the lower section of FIG. 11, the RB of the largest RB number is RB #10, among RB #10 to RB #8 to which the uplink data from mobile station 1 at the time of retransmission is allocated. Therefore, mapping section 103 maps a response signal to the uplink data from mobile station 1 at the time of retransmission, to the downlink resource in which PHICH #5 associated with RB #10 is provided. In addition, as shown in the lower section of FIG. 11, the RB to which the uplink data from mobile station 2 at the time of retransmission is allocated is RB #7. Therefore, mapping section 103 maps a response signal to the uplink data from mobile station 2 at the time of retransmission, to the downlink resource in which PHICH #4 associated with RB #7 is provided.

That is, at the time of retransmission, a response signal to uplink data from mobile station 1 and a response signal to uplink data from mobile station 2 are transmitted using different PHICHs in the same way as in Embodiment 1, so that a PHICH collision between the mobile stations does not occur in the same way as in Embodiment 1.

As described above, according to the present embodiment, when a plurality of RBs are allocated to one mobile station, the PHICH associated with the RB of the smallest RB number is used at the time of the first transmission, and the PHICH associated with the RB of the largest RB number is used at the time of retransmission. In other words, at the time of retransmission, the PHICH associated with an RB of an RB number mirroring the RB number associated with the PHICH at the time of the first transmission is used. That is, when a PHICH associated with an RB of a smaller RB number (the smallest RB number in FIG. 11), among a plurality of RBs allocated to one mobile station, is used at the time of the first transmission, a PHICH associated with an RB of a larger RB number (the largest RB number in FIG. 11) is used at the time of retransmission. In other words, a plurality of RBs are hopped by mirroring while one PHICH associated with a group of RBs is hopped in synchronization with the hopping of a plurality of RBs. That is, this is equivalent to synchronization of an FH pattern to hop a plurality of RBs and an FH pattern to hop plurality of PHICHs associated with RBs per group in the same way as in Embodiment 1, based on the assumption of a hopping pattern to hop PHICHs. By this means, associations between RBs and PHICHs to use at the time of retransmission is the same as at the time of the first transmission although RB numbers and channel numbers of PHICHs are placed in the mirror image relationship. That is, when scheduling is performed to prevent PHICH collisions between mobile stations at the time of the first transmission, it is possible to prevent PHICH collisions between mobile stations also at the time of retransmission.

As described above, according to the present embodiment, even if an FH pattern to mirror a plurality of RBs is used, it is possible to prevent PHICH collisions between mobile stations when combination of an FH retransmission method and a PHICH grouping method is used, in the same way as in Embodiment 1.

Here, with the present embodiment, a case has been described where when uplink data from one mobile station is allocated to a plurality of RBs, mapping section 103 switches between using the PHICH associated with the RB of the smallest RB number and using the PHICH associated with the RB of the largest RB number, in accordance with the number of times of retransmissions. However, according to the present invention, when uplink data from one mobile station is allocated to a plurality of RBs, mapping section 103 may switch between using the PHICH associated with the RB of the smallest RB number and using the PHICH associated with the RB of the largest RB number on a per retransmission basis, for example, for every subframes corresponding to an RTT (round trip time). Here, each mobile station simultaneously transmits uplink data (transmission data) to the base station at subframe intervals corresponding to an RTT. The time of retransmission is the same but the number of times of retransmissions is different between mobile stations, so that when PHICHs to use are switched based on the number of times of retransmissions, there may be a mobile station to use the PHICH associated with the RB of the smallest RB number and a mobile station to use the PHICH associated with the RB of the largest RB number. By contrast with this, when PHICHs to use are switched based on subframes corresponding to an RTT, which is the retransmission unit, it is possible to use PHICHs by switching PHICHs in common between mobile stations. That is, at the same time, all mobile stations use the PHICH associated with the RB of the smallest RB number (or the largest RB number). By this means, it is possible to further prevent PHICH collisions between mobile stations.

### Embodiment 3

The present embodiment is the same as Embodiment 2 in using the FH pattern to mirror a plurality of RBs but is different from Embodiment 2 in grouping only RBs less frequently used to allocate uplink data and associating PHICHs with RBs per group.

In the FH pattern shown in FIG. 4, the RB located in each end, for example, RB #1 (or RB #10), among RB #1 to RB #10, is hopped to RB #10 (or RB #1), which is nine RBs apart, and RB (or RB #9) is hopped to RB #9 (or RB #2), which is seven RBs apart. As described above, the RBs located in both ends, among RB #1 to RB #10, produce a high frequency diversity effect by frequency hopping. Therefore, uplink data from mobile stations are preferentially allocated to the RBs located in both ends, among RB #1 to RB #10, by scheduling. That is, the RBs located in both ends are frequently used in frequency hopping.

On the other hand, RBs located near the center among RB #1 to RB #10, for example, RB #3 to RB #8, are hopped to RBs which are maximum five apart, in the FH pattern shown in FIG. 4. By this means, RBs located near the center among RB #1 to RB #10 produce lower frequency diversity effect by frequency hopping than RBs located in both ends. Therefore, uplink data from mobile stations is controlled not to be frequently allocated to RBs located near the center by scheduling. That is, RBs located near the center are less frequently used in frequency hopping than RBs located in both ends.

Therefore, in the present embodiment, only RBs located near the center are subject to grouping into groups each associated with one PHICH. In other words, RBs other than RBs located near the center, that is, the RBs located in both ends are not subject to grouping.

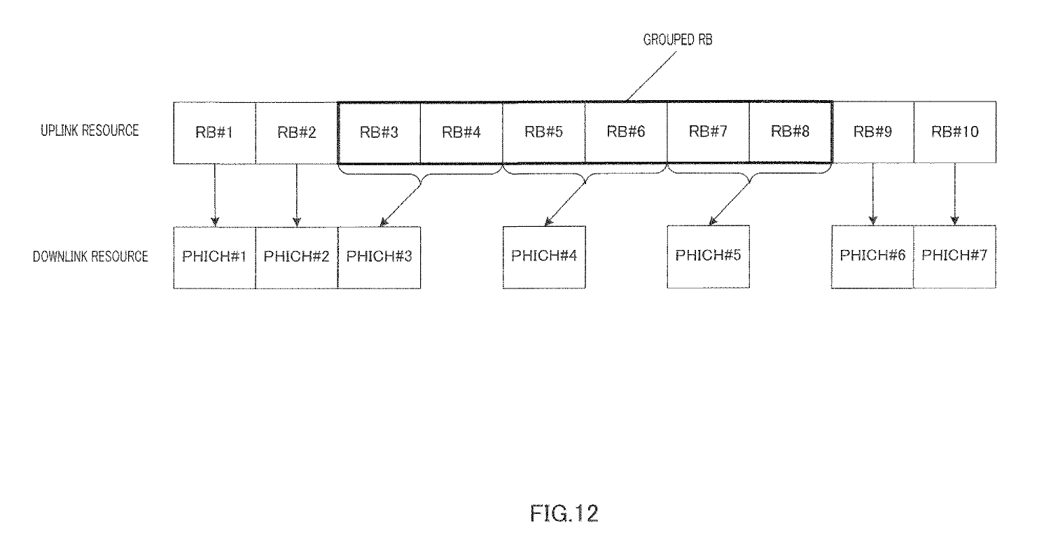

This will be described in detail below. According to the present embodiment, base station 100 receives uplink data from each mobile station using any of uplink RB #1 to RB #10 shown in FIG. 12. Then, base station 100 provides a response signal (ACK signal or NACK signal) to the uplink data in PHICH #1 to PHICH #7 shown in FIG. 12, and transmits the response signal to each mobile station.

In addition, as shown in FIG. 12, only RB #3 to RB #8 (RBs located near the center), among RB #1 to RB #10, are targets which are grouped into a plurality of groups and associated with PHICHs. Therefore, as shown in FIG. 12, RB #3 to RB #8 are grouped into three groups for every two consecutive RBs, and each group of RBs is associated with one PHICH. To be more specific, as shown in

FIG. 12, RB #3 and RB #4 are grouped and PHICH #3 is associated with a group composed of RB #3 and RB #4, RB #5 and RB #6 are grouped and PHICH #4 is associated with a group composed of RB #5 and RB #6, and RB #7 and RB #8 are grouped and PHICH #5 is associated with a group composed of RB #7 and RB #8.

In addition, PHICHs are associated with RBs other than the RBs to be grouped, that is, are associated with RBs #1, #2, #9 and #10 located in both ends, one-on-one. To be more specific, as shown in FIG. 12, PHICH #1 is associated with RB #1, PHICH #2 is associated with RB #2, PHICH #6 is associated with RB #9 and PHICH #7 is associated with RB #10.

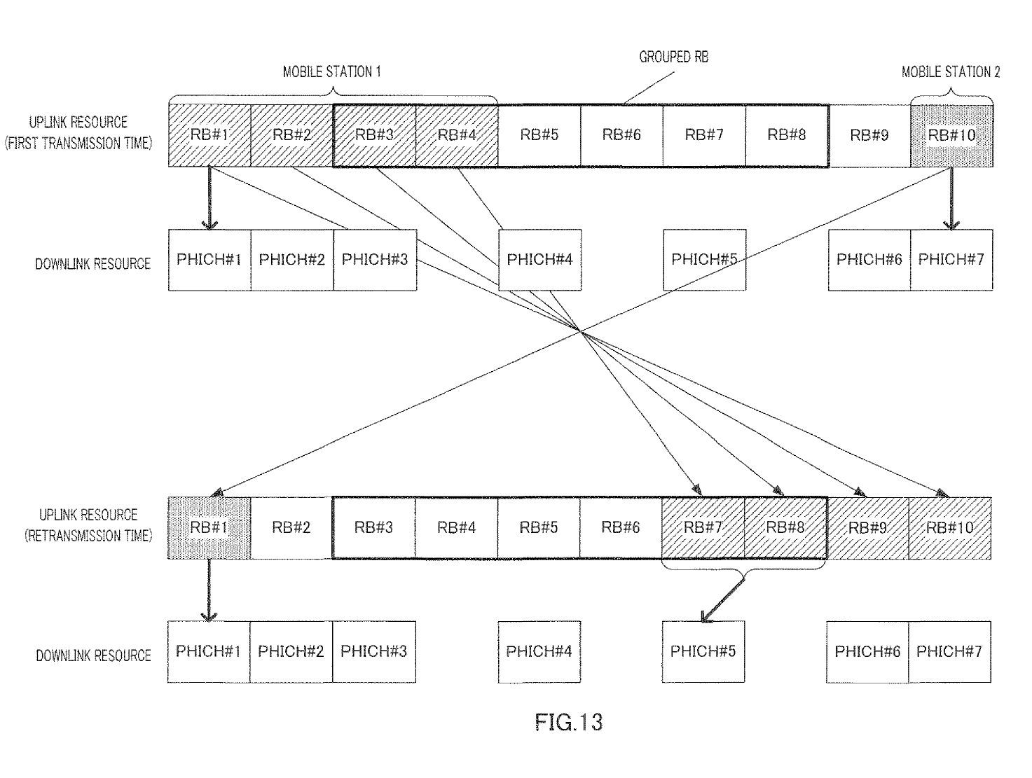

Next, a case will be described here where, for example, uplink data from mobile station 1 is allocated to RB #1 to RB #4 and uplink data from mobile station 2 is allocated to RB #10 at the time of the first transmission in the same way as in Embodiment 1, as shown in the upper section of FIG. 13. In addition, a case will be described here where uplink data from each of mobile station 1 and mobile station 2, which is extracted in demultiplexing section 115, has an error, and therefore it is necessary to feed a NACK signal back to each mobile station as a response signal to the uplink data from each mobile station in the same way as in Embodiment 1.

In this case, as shown in the upper section of FIG. 13, the RB of the smallest RB number is RB #1, among RB #1 to RB 44 to which the uplink data from mobile station 1 at the time of the first transmission is allocated. Therefore, mapping section 103 maps a response signal to the uplink data from mobile station 1 at the time of the first transmission, to the downlink resource in which PHICH #1 associated with RB #1 is provided. Likewise, mapping section 103 maps the response signal to the uplink data from mobile station 2 at the time of the first transmission, to the downlink resource in which PHICH #7 associated with RB #10 is provided.

Next, at the time of retransmission, demultiplexing section 115 which received, as input, uplink data at the time of retransmission from each mobile station, extracts the uplink data allocated to RB #10 to RB #7 from mobile station 1 at the time of retransmission and the uplink data allocated to RB #4 from mobile station 2 at the time of retransmission, as shown in the lower section of FIG. 13.

Then, mapping section 103 maps a response signal (ACK signal or NACK signal) to the uplink data from each mobile station at the time of retransmission, to downlink resources in which PHICHs are provided in the same way as at the time of the first transmission. To be more specific, as shown in the lower section of FIG. 13, the RB of the smallest RB number is RB #7, among RB #10 to RB #7 to which the uplink data from mobile station 1 at the time of retransmission is allocated. Therefore, mapping section 103 maps a response signal to the uplink data from mobile station 1 at the time of retransmission, to the downlink resource in which PHICH #5 associated with RB #7 is provided. Likewise, as shown in the lower section of FIG. 13, the RB to which the uplink data from mobile station 2 at the time of retransmission is allocated is RB #1. Therefore, mapping section 103 maps a response signal to the uplink data from mobile station 2 at the time of retransmission, to the downlink resource in which PHICH #1 associated with RB #1 is provided.

As described above, when RBs (RBs #1, #2, #9 and #10 shown in FIG. 12) located in both ends, which are more frequently used in uplink data allocation, are used in a plurality of mobile stations at the same time, RBs and PHICHs are associated with each other one-on-one, so that a PHICH collision does not occur.

In addition, as for RBs (RB #3 to RB #8 shown in FIG. 12) located near the center, which are less frequently used in uplink data allocation, it is possible to prevent PHICH collisions in the same way as in Embodiment 2 by using combination of an FH retransmission method and a PHICH grouping method in the same way as in Embodiment 2. In addition, the possibility that RBs (RB #3 to RB #8 shown in FIG. 12) located near the center are used in a plurality of mobile stations at the same time, is low. Therefore, the possibility of occurrence of PHICH collisions between different mobile stations is reduced, so that the influence on the entire system is reduced.

As described above, according to the present embodiment, RBs more frequently to allocate uplink data are associated with PHICHs one-on-one, and RBs less frequently to allocate uplink data are grouped into a plurality of groups every plurality of RBs and associated with PHICHs for every group. By this means, a PHICH used to a mobile station using RBs frequently used to allocate uplink data and a PHICH used to another mobile station do not collide. In addition, the possibility that PHICHs used in a mobile station using RBs less frequently used to allocate uplink data are used in another mobile station is low, so that the possibility of a PHICH collision between the mobile stations is reduced. Therefore, according to the present embodiment, it is possible to prevent a PHICH collision between the mobile stations in the same way as in Embodiment 2.

Here, with the present embodiment, a case has been described where uplink RBs used to allocate uplink data are classified into two types (more frequently used RBs and less frequently used RBs) in accordance with the frequency of use. However, according to the present invention, uplink RBs used to allocate uplink data may be classified into three types or more in accordance with the frequency of use. Then, association with PHICHs may vary for every RBs classified into different types.

Embodiments of the present invention have been described.

Here, the above-described embodiments may be combined in the present invention. For example, combination of Embodiment 1 and Embodiment 2 may be used. To be more specific, uplink RBs are blocked into a plurality of blocks and a plurality of RBs are hopped on a per block basis according to Embodiment 1, and RBs may further hopped in each block according to Embodiment 2. Otherwise, uplink RBs may be blocked into a plurality of blocks according to Embodiment 1, and a plurality of RBs may be hopped on a per block basis according to Embodiment 2.

In addition, subframes used in the above descriptions may be other units of transmission time, for example, timeslots and frames.

Moreover, a mobile station, base station, and subcarrier may be referred to as UE, node B and tone. Moreover, a CP may be referred to as a guard interval (GI).

Furthermore, the frequency multiplexing method is not limited to OFDM and SC-FDMA.

Furthermore, a SCCH used in the above-described embodiments may be any channel as long as a control channel for reporting the result of uplink data resource allocation. For example, a PDCCH (physical downlink control channel) may be used instead of the SCCH.

Moreover, with the above-described embodiments, although operations at the time of the first transmission and until the time of the first retransmission have been described, uplink data may be retransmitted by repeating the operation at the time of the first transmission when uplink data is retransmitted again.

Also, although cases have been described with the above embodiment as examples where the present invention is configured by hardware, the present invention can also be realized by software.

Each function block employed in the description of each of the aforementioned embodiments may typically be implemented as an LSI constituted by an integrated circuit. These may be individual chips or partially or totally contained on a single chip. “LSI” is adopted here but this may also be referred to as “IC,” “system LSI,” “super LSI,” or “ultra LSI” depending on differing extents of integration.

Further, the method of circuit integration is not limited to LSI's, and implementation using dedicated circuitry or general purpose processors is also possible. After LSI manufacture, utilization of a programmable FPGA (Field Programmable Gate Array) or a reconfigurable processor where connections and settings of circuit cells within an LSI can be reconfigured is also possible.

Further, if integrated circuit technology comes out to replace LSI's as a result of the advancement of semiconductor technology or a derivative other technology, it is naturally also possible to carry out function block integration using this technology. Application of biotechnology is also possible.

The disclosure of Japanese Patent Application No. 2008-079032, filed on Mar. 25, 2008, including the specification, drawings and abstract, is incorporated herein by reference in its entirety.

### INDUSTRIAL APPLICABILITY

The present invention is applicable to a mobile communication system and so forth.

1-3. (canceled)

4. A radio communication apparatus comprising:
an extracting section that extracts channel data allocated to a plurality of resource blocks in accordance with a hopping pattern, the plurality of resource blocks being blocked into a plurality of blocks for every M consecutive resource blocks (M is a natural number) and hopped every block on a per block basis; and
a mapping section that maps a response signal to the channel data, to channel resources in which a plurality of control channels are provided, in accordance with associations between the plurality of control channels and a plurality of groups into which the plurality of resource blocks are grouped for every N consecutive resource blocks (N is a natural number),
wherein M is a natural number multiple of N.

5. The radio communication apparatus according to claim 4, wherein M and N are the same number.

6. A radio communication method comprising the steps of:
extracting channel data allocated to a plurality of resource blocks in accordance with a hopping pattern, the plurality of resource blocks being blocked into a plurality of blocks for every M consecutive resource blocks (M is a natural number) and hopped every block on a per block basis; and
mapping a response signal to channel data, to channel resources in which a plurality of control channels are provided, in accordance with associations between the plurality of control channels and a plurality of groups into which the plurality of resource blocks are grouped for every N consecutive resource blocks (N is a natural number),
wherein M is a natural number multiple of N.

7. A radio communication apparatus comprising:
an allocating section that allocates channel data to a plurality of resource blocks in accordance with a hopping pattern, the plurality of resource blocks being blocked into a plurality of blocks for every M consecutive resource blocks (M is a natural number) and hopped every block on a per block basis; and
a receiving section that receives a response signal to the channel data allocated to a plurality of control channels, in accordance with associations between the plurality of control channels and a plurality of groups into which the plurality of resource blocks are grouped for every N consecutive resource blocks (N is a natural number),
wherein M is a natural number multiple of N.
